(19) United States
(12) Patent Application Publication
(10) Pub. No.: US 2019/0058913 A1
(43) Pub. Date: Feb. 21, 2019

(54) DISPLAY DEVICE AND DISPLAY METHOD

(71) Applicant: Samsung Electronics, Co., Ltd., Suwon-si, Gyeonggi-do (KR)

(72) Inventors: Han-sol PARK, Seoul (KR); Jang-won Seo, Seoul (KR)

(73) Assignee: Samsung Eledctronics Co., Ltd., Suwon-si, Gyeonggi-do (KR)

(21) Appl. No.: 15/770,595

(22) PCT Filed: Aug. 18, 2016
(86) PCT No.: PCT/KR2016/009053

§ 371 Date: Apr. 24, 2018

(30) Foreign Application Priority Data
Dec. 17, 2015 (KR) 10-2015-0181085

(51) Int. Cl. H04N 21/422; H04N 21/4402; H04N 21/442; G06F 3/038; G06F 3/14; G09G 5/00

(52) U.S. Cl. CPC H04N 21/422; H04N 21/4402; G09G 5/003; G06F 3/038; G06F 3/1446; H04N 21/442

(57) ABSTRACT

A display apparatus and a display method according to embodiments are disclosed. The display apparatus according to an embodiment includes: a display configured to display a user interface representing a process for pairing the display apparatus with another device; and a processor configured to control the display to display a first user interface representing loading of the process, a changing user interface representing a state of change from the first user interface to a second user interface representing execution of the loaded process, and the second user interface.

### TECHNICAL FIELD

The present disclosure relates to a display apparatus and a display method, and more particularly, to a display apparatus and a display method for displaying a user interface representing a state of the display apparatus.

### BACKGROUND ART

A display apparatus is an apparatus having a function of displaying images that a user can watch. The user can watch broadcast content through the display apparatus. The display apparatus may display broadcast content selected by a user from broadcasting signals transmitted from broadcasting stations, on a display. Recently, there is a worldwide trend of conversion from analog broadcasting to digital broadcasting.

Digital broadcasting means broadcasting to transmit digital images and voice signals. Digital broadcasting has low data loss since it is robust to external noise compared to analog broadcasting, has an advantage in terms of error correction, has high resolution, and provides clear images. Also, digital broadcasting enables bidirectional services unlike in the case of analog broadcasting.

Recently, display apparatuses provide various bidirectional services to users in addition to them watching the broadcast content. When a display apparatus provides a bidirectional service to a user, the display apparatus can display various user interfaces in order to effectively interact with the user.

More specifically, the user interfaces can include icons for displaying a state of the display apparatus for the user. For example, the user interfaces can display a loading state of content for the display apparatus, a connection state with respect to the user's mobile terminal, etc.

### DETAILED DESCRIPTION OF THE INVENTION

### Technical Problem

According to embodiments of the present disclosure, there is provided a method of enabling a display apparatus to seamlessly connect and display functions being currently performed on the display apparatus, when displaying a state of the display apparatus to a user.

### Technical Solution

A display apparatus according to an embodiment may include: a display configured to display a user interface representing a process for pairing between the display apparatus and another device; and a processor configured to control the display to display a first user interface representing loading of the process, a changing user interface representing a state of change from the first user interface to a second user interface representing execution of the loaded process, and the second user interface.

The first user interface, the changing user interface, and the second user interface of the display apparatus according to an embodiment may include animated parts, and the processor according to an embodiment may control the animated parts of the first user interface, the changing user interface, and the second user interface to move in the same direction.

The processor according to an embodiment may control the animated parts of the first user interface, the changing user interface, and the second user interface to move along a circular trajectory.

When the first user interface, the second user interface, and the second user interface are displayed sequentially, the processor according to an embodiment may control the animated parts of the first user interface, the changing user interface, and the second user interface to be connected on the circular trajectory.

The processor according to an embodiment may control the changing user interface to be displayed based on moving speed of the animated part of the first user interface.

In the display apparatus according to an embodiment, the changing user interface may represent operation of filling the inside of the circular trajectory drawn by the animated part of the first user interface with one of colors included in the second user interface according to a direction of the movement.

The process according to an embodiment may include a connection process for connecting the display apparatus to the other device, and the changing user interface according to an embodiment may represent operation in which a pairing item representing pairing between the display apparatus and the other device is created around the first user interface.

The process according to an embodiment may include at least one of a search process for searching for another device to be paired with the display apparatus, a connection process for connecting the display apparatus to the other device, and a completion process for displaying a connection state between the display apparatus and the other device.

The processor according to an embodiment may perform control for displaying a notification window before loading the process, and perform control for displaying a state in which the notification window changes to the first user interface, based on an input for executing the process.

The process of the display apparatus according to an embodiment may include a connection process for connecting the display apparatus to the other device, and the notification window according to an embodiment may include a user interface for receiving a user input for executing the connection process.

According to an aspect of another embodiment, A display method according to an embodiment may be a method of displaying a user interface representing a process for pairing between a display apparatus and another device.

The display method according to an embodiment may include: displaying a first user interface representing loading of the process; displaying a changing user interface representing a state of change from the first user interface to a second user interface representing execution of the loaded process; and displaying the second user interface.

In the display method according to an embodiment, the first user interface, the changing user interface, and the second user interface may include animated parts, and the animated parts of the first user interface, the changing user interface, and the second user interface may move in the same direction.

In the display method according to an embodiment, the animated parts of the first user interface, the changing user interface, and the second user interface may move along a circular trajectory.

In the display method according to an embodiment, when the first user interface, the second user interface, and the second user interface are displayed sequentially, the animated parts of the first user interface, the changing user interface, and the second user interface may be connected on the circular trajectory.

The displaying of the changing user interface according to an embodiment may include displaying the changing user interface based on moving speed of the animated part of the first user interface.

The displaying of the changing user interface according to an embodiment may include displaying operation of filling the inside of the circular trajectory drawn by the animated part of the first user interface with one of colors included in the second user interface according to a direction of the movement of the moving part.

In the display method according to an embodiment, the process may include a connection process for connecting the display apparatus to the other device, and the displaying of the changing user interface according to an embodiment may include displaying operation in which a pairing item representing pairing between the display apparatus and the other device is created around the first user interface.

In the display method according to an embodiment, the process may include at least one of a search process for searching for another device to be paired with the display apparatus, a connection process for connecting the display apparatus to the other device, and a completion process for displaying a connection state between the display apparatus and the other device.

The display method according to an embodiment may further include: displaying a notification window before loading the process; and displaying a state in which the notification window changes to the first user interface, based on an input for executing the process.

Computer-readable recording medium according to an embodiment may record a program for executing the display method according to the embodiments.

### Advantageous Effects of the Invention

According to the display apparatus and the display method disclosed in the present specification, a method of enabling the display apparatus to seamlessly connect and display functions being currently performed on the display apparatus, when displaying a state of the display apparatus to a user can be provided.

### DESCRIPTION OF THE DRAWINGS

FIG. 1 shows a display apparatus 100 according to an embodiment.

FIG. 2 is a block diagram of the display apparatus 100 according to the embodiment and a control apparatus 200 that is connected to the display apparatus 100 to be operable.

FIG. 3 is a view for describing user interfaces representing a search process, according to an embodiment.

FIG. 4A shows a first user interface of the search process, displayed by the display apparatus 100.

FIG. 4B shows a changing user interface of the search process, displayed by the display apparatus 100.

FIG. 4C shows a second user interface of the search process, displayed by the display apparatus 100.

FIG. 5 is a view for describing user interfaces representing a connection process, according to an embodiment.

FIG. 6A shows a first user interface of the connection process, displayed by the display apparatus 100.

FIG. 6B shows a changing user interface of the connection process, displayed by the display apparatus 100.

FIG. 6C shows a second user interface of the connection process, displayed by the display apparatus 100.

FIG. 7 is a view for describing user interfaces representing a completion process, according to an embodiment.

FIG. 8A shows a first user interface of the completion process, displayed by the display apparatus 100.

FIG. 8B shows a changing user interface of the search process, displayed by the display apparatus 100.

FIG. 8C shows a second user interface of the completion process, displayed by the display apparatus 100.

FIG. 9 shows a case of displaying a notification window before loading a process, according to an embodiment.

FIG. 10 is a flowchart of a method of operating the display apparatus 100, according to the embodiment.

FIG. 11 is a schematic configuration diagram of a display apparatus 100a according to another embodiment.

FIG. 12 is a block diagram showing a configuration of a control apparatus 200a according to another embodiment.

### BEST MODE

Hereinafter, exemplary embodiments of the present disclosure will be described in detail with reference to content written in the accompanying drawings. Also, a method of configuring and using an electronic apparatus according to an embodiment of the present disclosure will be described in detail with reference to the content written in the accompanying drawings. Also, like reference numerals or symbols denoted in the drawings represent members or components that perform the substantially same functions.

It will be understood that, although the terms first, second, etc. may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

The terms used in the present specification are used to describe the embodiments of the present disclosure, not for the purpose of limiting the present disclosure. It is to be understood that the singular forms “a,” “an,” and “the” include plural referents unless the context clearly dictates otherwise. It will be understood that when the terms “includes,” “comprises,” “including,” and/or “comprising,” when used in this specification, specify the presence of stated features, figures, steps, components, or combination thereof, but do not preclude the presence or addition of one or more other features, figures, steps, components, members, or combinations thereof.

In the entire specification, a ‘display’ may mean a component to perform a function of outputting image data visually. Also, according to an implementation example, if a display panel and a touch pad included in a display form a layered structure to configure a touch screen, the display can be used as an input apparatus, as well as an output apparatus. The display may include at least one among a Liquid Crystal Display (LCD), a Thin Film Transistor-Liquid Crystal Display (TFT-LCD), an Organic Light-Emitting Diode (OLED) Display, a flexible display, a 3Dimensional (3D) display, an electrophoretic display, a Plasma Display Panel (PDP) display, and a Quantum dot LED (QLED) display.

A ‘display apparatus’, which is a kind of an output apparatus including the above-described display, is an apparatus capable of displaying image data visually. The display apparatus may connect to a desktop, a notebook, a tablet PC, a camera, a mobile phone, storage medium, and another electronic device to receive image data in a wireless or wired fashion. According to an implementation example, the display apparatus may receive analog broadcasting signals or digital broadcasting signals. The display apparatus may be implemented as a flat display apparatus, a curved display apparatus having a curvature, or a flexible display apparatus having an adjustable curvature. Also, the display apparatus may include a PC monitor, a TV monitor, etc., and may also include a Large Format Display (LFD). Also, according to an implementation type of the display apparatus, the display apparatus may include two displays or more.

An area on which content is output in the display of the display apparatus can be referred to as a screen.

Also, in this specification, the term ‘user’ means a person who controls functions or operations of the display apparatus, and may include a manager or an installation engineer.

The terms used in the present specification are used to describe the embodiments of the present disclosure, not for the purpose of limiting the present disclosure. It is to be understood that the singular forms “a,” “an,” and “the” include plural referents unless the context clearly dictates otherwise. It will be understood that when the terms “includes,” “comprises,” “including,” and/or “comprising,” when used in this specification, specify the presence of stated features, figures, steps, components, or combination thereof, but do not preclude the presence or addition of one or more other features, figures, steps, components, members, or combinations thereof.

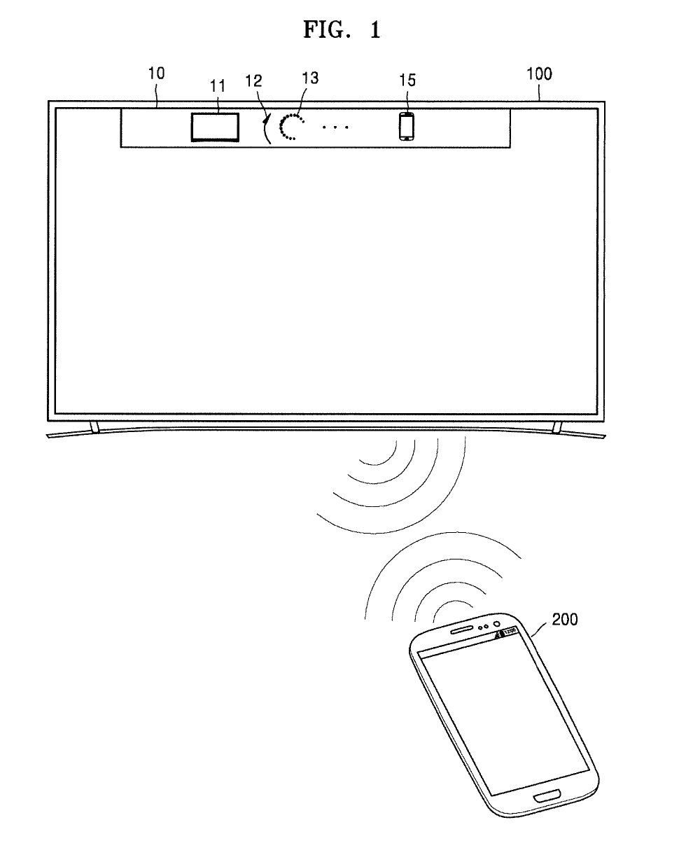

FIG. 1 shows a display apparatus 100 according to an embodiment.

Referring to FIG. 1, the display apparatus 100 according to an embodiment may display a user interface representing a state of the display apparatus 100.

The state of the display apparatus 100 may be information about operation or contents being currently executed on the display apparatus 100. Also, the state of the display apparatus 100 may include information about a control apparatus 200 currently connected to the display apparatus 100 to be operable.

Referring to FIG. 1, for example, the display apparatus 100 may represent operation being executed on the display apparatus 100 through a user interface 10. More specifically, the operation being executed on the display apparatus 100 may be wireless connection operation between the display apparatus 100 and the control apparatus 200, and the display apparatus 100 may represent information related to the wireless connection operation between the display apparatus 100 and the control apparatus 200 through the user interface 10.

More specifically, the user interface 10 representing a state in which the display apparatus 100 is wirelessly connected to the control apparatus 200 may include items 11, 13, and 15. The items 11, 13, and 15 may be a Graphic User Interface (GUI) for interacting with a user by providing information related to the display apparatus 100 to the user.

The items 11, 13, and 15 may include animated parts, and include static parts. The animated parts may mean parts animated for representing motion.

For example, the item 13 may include an animated part. More specifically, referring to FIG. 1, the animated part of the item 13 may include a part rotating in a clockwise direction 12. If the item 13 including the animated part is displayed, the user can recognize that the display apparatus 100 is being wirelessly connected to the control apparatus 200.

Meanwhile, the control apparatus 200 may include an apparatus that can connect to the display apparatus 100 in a wired or wireless fashion to be operable. The control apparatus 200 may be inter-connected to the display apparatus 100 through a wired or wireless connection. The inter-connection means that bidirectional signal exchange between the display apparatus 100 and the control apparatus 200 is allowed, not that the display apparatus 100 receives signals unidirectionally.

For example, the display apparatus 100 may use Bluetooth which is a short-range wireless technology standard, in order to be paired with the control apparatus 200 and connect to the control apparatus 200. A state in which the display apparatus 100 was inter-connected to the control apparatus 200 by Bluetooth can be called that the display apparatus 100 was paired with the control apparatus 200.

In FIG. 1, according to an embodiment, a case in which the control apparatus 200 is a smart phone is shown. Also, the control apparatus 200 may include an apparatus that can be inter-connected to the display apparatus 100 through a wireless connection. More specifically, the control apparatus 200 may include a wireless keyboard, a remote controller, a notebook, a tablet PC, etc.

Hereinafter, a specific embodiment providing a method of displaying a state of progress seamlessly without any interruption when the display apparatus 100 displays a function being executed on the display apparatus 100 will be described.

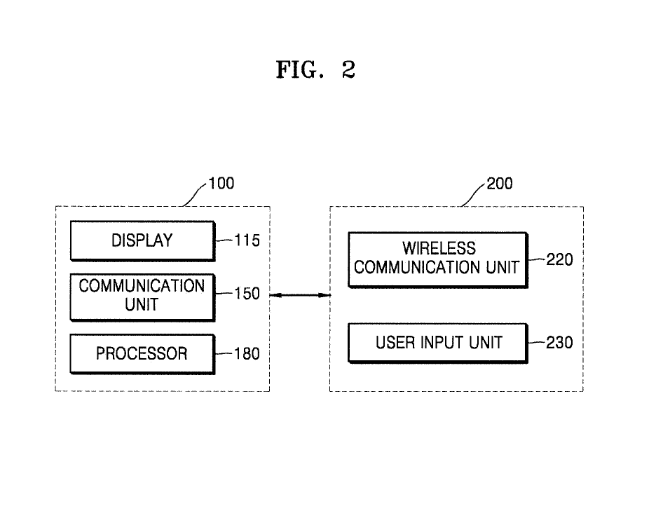

FIG. 2 is a block diagram of the display apparatus 100 according to the embodiment and the control apparatus 200 that can be connected to the display apparatus 100 in a wired or wireless fashion to be operable.

Referring to FIG. 2, the display apparatus 100 may include a display 115, a communication unit 150, and a processor 180.

The display apparatus 100 may seamlessly connect and display functions that are executed on the display apparatus 100. For example, a function that is executed on the display apparatus 100 may be a process for pairing between the display apparatus 100 and another device. Herein, the other device may include an apparatus that can be paired with the display apparatus 100, and is not limited to a specific apparatus. More specifically, the other device may include, for example, a smart phone, a wireless keyboard, a remote controller, a notebook, a tablet PC, etc., and may include the control apparatus 200 shown in FIG. 2.

The display 115 according to an embodiment may display a user interface representing a process for pairing between the display apparatus 100 and another device.

The process for pairing with the other device may include, for example, a search process for searching for another device to be paired with the display apparatus 100, a connection process for connecting the display apparatus 100 to another device, and a completion process for displaying a connection state between the display apparatus 100 and another device. The process for pairing with the other device may include all of the above-described three processes, or at least one of the above-described three processes.

According to an embodiment, the display apparatus 100 may first load the search process, in order to connect to another device.

The search process may be a process for searching for the control apparatus 200 that can be paired with the display apparatus 100. The display apparatus 100 may execute the loaded search process, and then recognize that the control apparatus 200 capable of being paired with the display apparatus 100 exists within a short distance from the display apparatus 100.

If the display apparatus 100 recognizes the control apparatus 200 capable of being paired with the display apparatus 100, the display apparatus 100 may terminate the search process.

According to an embodiment, the display apparatus 100 may load the connection process, in order to connect to the control apparatus 200 recognized in the search process.

Connecting the display apparatus 100 to another device in the connection process may mean pairing for a wireless connection to another device searched in the search process.

If the display apparatus 100 is paired with the control apparatus 200 in the connection process, the display apparatus 100 may terminate the connection process. Also, although the display apparatus 100 fails to be paired with the control apparatus 200, the display apparatus 100 may terminate the connection process after a predetermined time period elapses from when executing the connection process.

According to an embodiment, if the display apparatus 100 terminates the connection process for connecting to the control apparatus 200, the display apparatus 100 may execute the completion process.

In the completion process, the display apparatus 100 may display information about the control apparatus 200 paired with the display apparatus 100 in the connection process. Also, in the completion process, the display apparatus 100 may display information about whether or not the display apparatus 100 has been paired with the control apparatus 200 in the connection process of trying to pairing.

The processor 180 according to an embodiment may control the display 115 to display a first user interface representing loading of a process for pairing with another device, a changing user interface representing a state of change from the first user interface to a second user interface representing execution of the loaded process, and the second user interface.

Also, the processor 180 may control the display 115 such that animated parts of the first user interface, the changing user interface, and the second user interface move along a circular trajectory.

Also, when the first user interface, the changing user interface, and the second user interface are displayed sequentially, the processor 180 may control the display 115 such that the animated parts of the first user interface, the changing user interface, and the second user interface are connected on the circular trajectory.

Also, the processor 180 may display the changing user interface on the display 115, based on moving speed of the animated part of the first user interface. For example, the processor 180 may display the changing user interface on the display 115 such that the changing user interface represents operation of filling the inside of a circular trajectory drawn by the animated part of the first user interface with one of colors included in the second user interface according to a direction of the movement.

Also, the processor 180 may control the display 115 to display a notification window before loading a process, and to display a state in which the notification window changes to the first user interface, based on an input for executing the process, on the display 115.

Also, the processor 180 may control the display 115 to represent operation in which a pairing item representing pairing between the display apparatus 100 and another device is created around the first user interface, through the changing user interface.

The communication unit 150 may connect the display apparatus 100 to the control apparatus 200 by the control of the processor 180. Also, the communication unit 150 may receive a control signal from the control apparatus 200 by the control of the processor 180. The control signal may be implemented as a Bluetooth type, an RF signal type, or Wi-Fi.

Meanwhile, referring to FIG. 2, the control apparatus 200 may include a wireless communication unit 220 and a user input unit 230.

The wireless communication unit 220 may transmit/receive signals to/from the display apparatus 100 according to the above-described embodiments. The wireless communication unit 220 may include a Bluetooth module (not shown) to transmit/receive Bluetooth type signals to/from the display apparatus 100.

The user input unit 230 may be configured with a keypad, a button, a touch pad, a touch screen, or the like. The user may manipulate the user input unit 230 to input a command related to the display apparatus 100 to the control apparatus 200. If the user input unit 230 includes a hard key button, the user may input a command related to the display apparatus 100 to the control apparatus 200 by pushing the hard key button. If the user input unit 230 includes a touch screen, the user may input a command related to the display apparatus 100 to the control apparatus 200 by touching the touch screen.

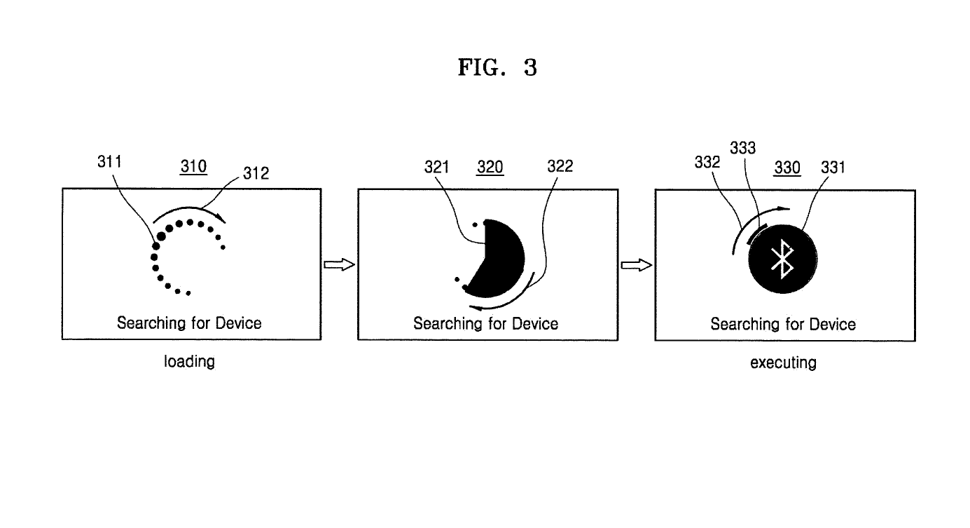

FIG. 3 is a view for describing user interfaces representing a search process according to an embodiment.

A search process according to an embodiment may be a process for searching for another device to be paired with the display apparatus 100.

Referring to FIG. 3, the display apparatus 100 may display a first user interface 310 representing loading of a search process, a changing user interface 320 representing a state of change from the first user interface 310 to a second user interface 330, and the second user interface 330 representing execution of the loaded search process.

The first user interface 310, the changing user interface 320, and the second user interface 330 may include animated parts. Herein, the animated parts may be parts displayed by animated.

Arrows shown in FIG. 3 may represent movement directions 312, 322, and 332 of the animated parts. The movement directions may include directions in which some items included in the user interfaces move on the display, while the other items are maintained in shape. Also, the movement directions may include movement directions that can be actually recognized by general users of the display apparatus 100 when the shapes of the items included in the user interfaces change.

For example, an animated part of the first user interface 310 may be an item 311, and a movement direction 312 of the animated part of the first user interface 310 may be a direction in which the item 311 rotates.

Also, for example, an animated part of the changing user interface 320 may be an item 321, and a movement direction 322 of the animated part of the changing user interface 320 may be a direction in which an area of the item 321 increases.

Also, for example, an animated part of the second user interface 330 may be an outline 333 rotating around an item 331, and a movement direction 332 of the animated part of the second user interface 330 may be a direction in which the outline 333 rotates.

Meanwhile, displaying the first user interface 310, the changing user interface 320, and the second user interface 330 including the animated parts may be called displaying animation sequences.

According to an embodiment, when the first user interface 310, the changing user interface 320, and the second user interface 330 including the animated parts are displayed sequentially, the display apparatus 100 may display the first user interface 310, the changing user interface 320, and the second user interface 330 such that the respective animation sequences of the first user interface 310, the changing user interface 320, and the second user interface 330 are connected seamlessly by each other as if the animation sequences look like an animation sequence.

Hereinafter, exemplary embodiments in which the first user interface 310, the changing user interface 320, and the second user interface 330 of the above-described search process are displayed respectively will be described in detail.

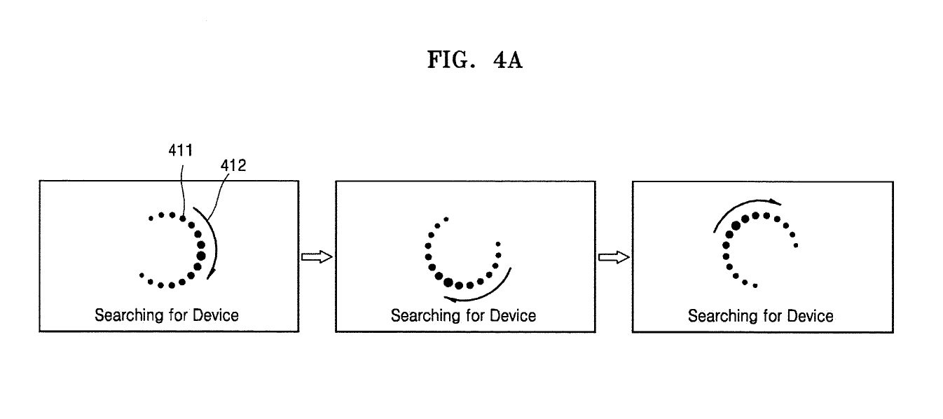

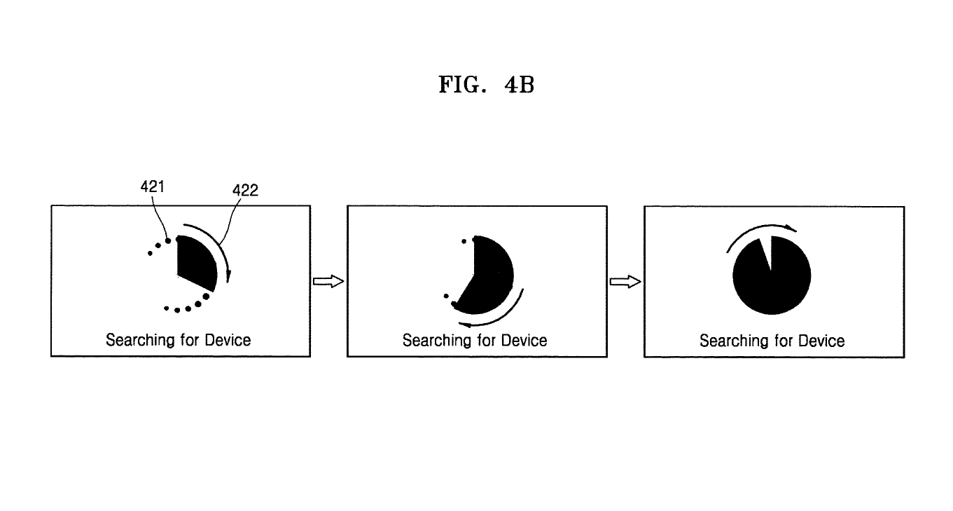

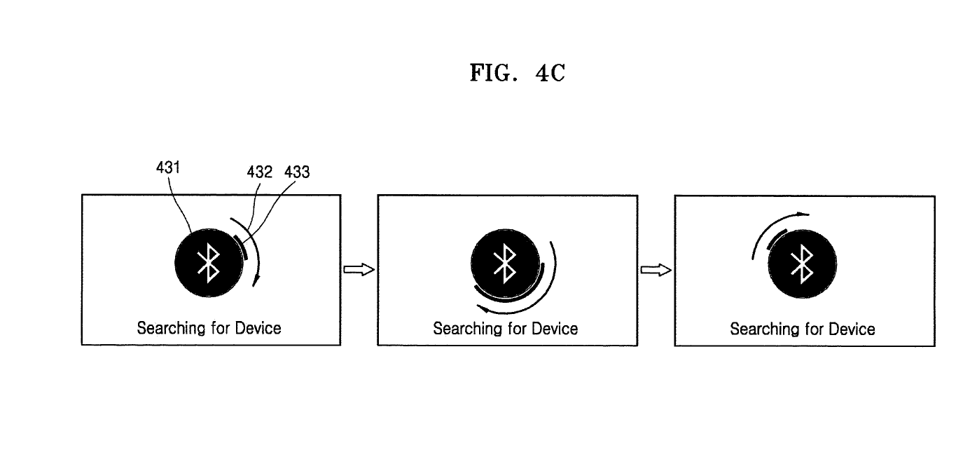

FIG. 4A shows a first user interface of a search process, displayed by the display apparatus 100.

Referring to FIG. 4A, the display apparatus 100 may display an animation sequence for representing a state in which a search process is loaded through a first user interface of the search process.

More specifically, the display apparatus 100 may display a rotating item 411 in order to represent loading operation through the first user interface. The item 411 may rotate on a predetermined circular trajectory along a movement direction 412.

FIG. 4B shows a changing user interface of the search process, displayed by the display apparatus 100.

Referring to FIG. 4B, the display apparatus 100 may display an animation sequence for representing a state in which the search process changes from the loading operation to execution operation through a changing user interface of the search process.

More specifically, the display apparatus 100 may display a state in which the first user interface changes to a second user interface, through the changing user interface.

That is, the display apparatus 100 may display a state in which an item (see 311 of FIG. 3) of the first user interface (see 310 of FIG. 3) changes to an item (see 331 of FIG. 3) of the second user interface (see 330 of FIG. 3), through the changing user interface.

The display apparatus 100 may perform control for displaying the animated part of the changing user interface based on moving speed of the animated part of the first user interface. Herein, the animated part of the changing user interface may correspond to a part in which an area of an item 421 increases. Also, a direction in which the area of the item 421 increases may correspond to a movement direction 422.

Speed at which the area of the item 421 increases may correspond to speed at which the item (see 411 of FIG. 4A) of the first user interface of FIG. 4A rotates.

Also, according to an embodiment, the display apparatus 100 may display, through the changing user interface, operation of filling the inside of the circular trajectory drawn by the animated part (for example, the item 411 of FIG. 4A) of the first user interface with one of colors included in the second user interface according to a direction of the movement.

FIG. 4C shows a second user interface of the search process, displayed by the display apparatus 100.

Referring to FIG. 4C, the display apparatus 100 may display, through a second user interface, an animation sequence for displaying a state in which the search process for searching for another device is being executed.

For example, the display apparatus 100 may display an outline 433 rotating around an item 431, through the second user interface. The outline 433 rotating around the item 431 may rotate according to a movement direction 432.

Referring to FIGS. 4A to 4C, the display apparatus 100 may control the movement directions 412, 422, and 432 of the animated parts of the first user interface, the changing user interface, and the second user interface of the search process to become the same direction.

Also, referring to FIGS. 4A to 4C, the display apparatus 100 may control the animated parts of the first user interface, the changing user interface, and the second user interface of the search process such that the movement directions of the animated parts draw a circular trajectory.

Also, the display apparatus 100 may control the animated parts to be connected on a circular trajectory, when displaying the first user interface, the changing user interface, and the second user interface of the search process sequentially.

Accordingly, the display apparatus 100 may display the first user interface, the changing user interface, and the second user interface of the search process such that the animation sequences of the first user interface, the changing user interface, and the second user interface are connected seamlessly by each other as if the animation sequences look like an animation sequence.

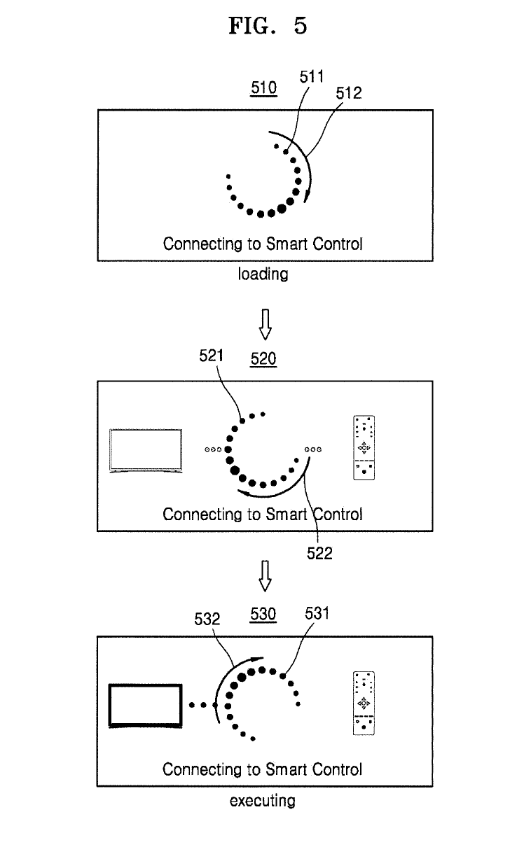

FIG. 5 is a view for describing user interfaces representing a connection process according to an embodiment.

A connection process according to an embodiment may be a process for connecting to another device to be paired with the display apparatus 100.

Referring to FIG. 5, the display apparatus 100 may display a first user interface 510 representing loading of a connection process, a changing user interface 520 representing a state of change from the first user interface 510 to a second user interface 530, and the second user interface 530 representing execution of the loaded search process.

The first user interface 510, the changing user interface 520, and the second user interface 530 may include animated parts. The animated parts may be parts displayed by animated.

Arrows shown in FIG. 5 may represent movement directions 512, 522, and 532 of the animated parts. The movement directions may include directions in which some items included in the user interfaces move on the display, while the other items are maintained in shape. Also, the movement directions may include movement directions that can be actually recognized by general users of the display apparatus 100 when the shapes of the items included in the user interfaces change.

For example, an animated part of the first user interface 510 may be an item 511, and a movement direction 512 of the animated part of the first user interface 510 may be a direction in which the item 511 rotates.

Also, an animated part of the changing user interface 520 may be an item 521, and a movement direction 522 of the animated part of the changing user interface 520 may be a direction in which the item 521 rotates.

Also, an animated part of the second user interface 530 may be an item 531, and a movement direction 532 of the animated part of the changing user interface 520 may be a direction in which the item 531 rotates.

As described above with reference to FIG. 3, the display apparatus 100 may display the first user interface 510, the changing user interface 520, and the second user interface 530 such that the animation sequences of the first user interface 510, the changing user interface 520, and the second user interface 530 are connected seamlessly by each other as if the animation sequences look like an animation sequence.

For example, the display apparatus 100 may control the animated parts of the first user interface 510, the changing user interface 520, and the second user interface 530 to be connected by each other on a circular trajectory, when displaying the first user interface 510, the changing user interface 520, and the second user interface 530 sequentially.

Hereinafter, exemplary embodiments in which the first user interface 510, the changing user interface 520, and the second user interface 530 of the above-described connection process are displayed respectively will be described in detail.

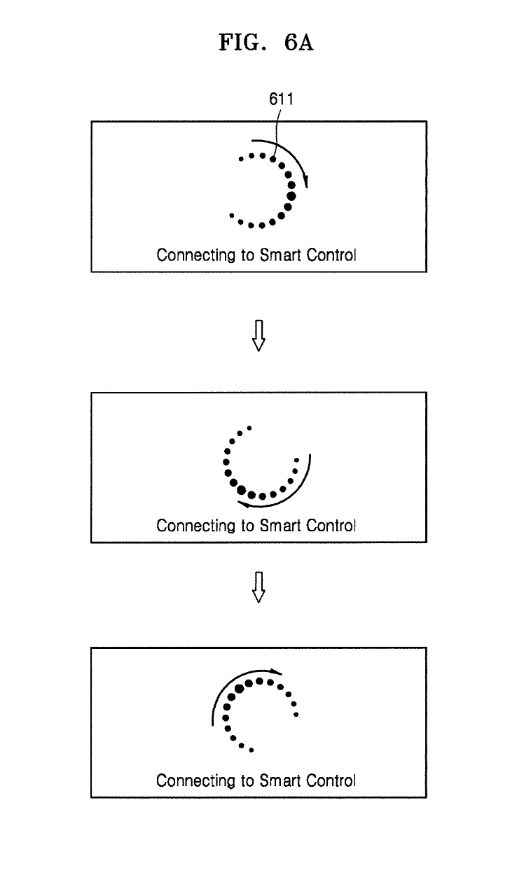

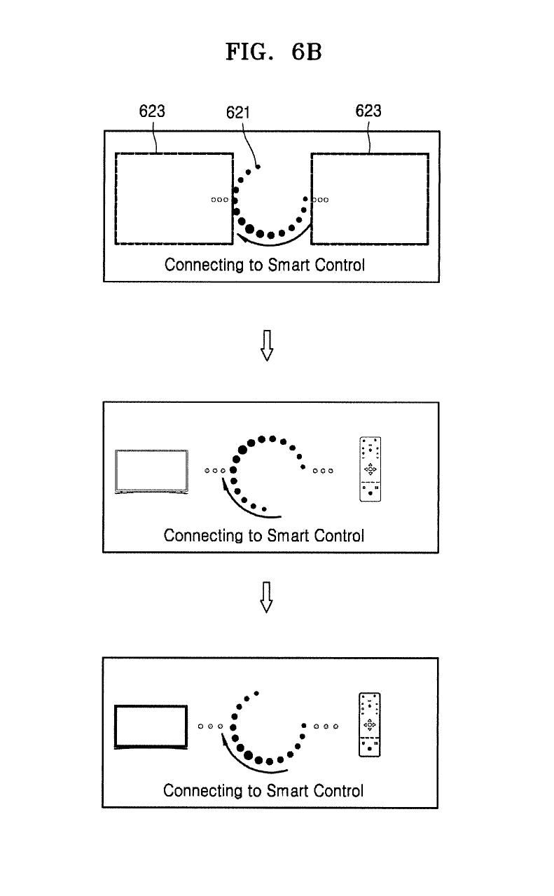

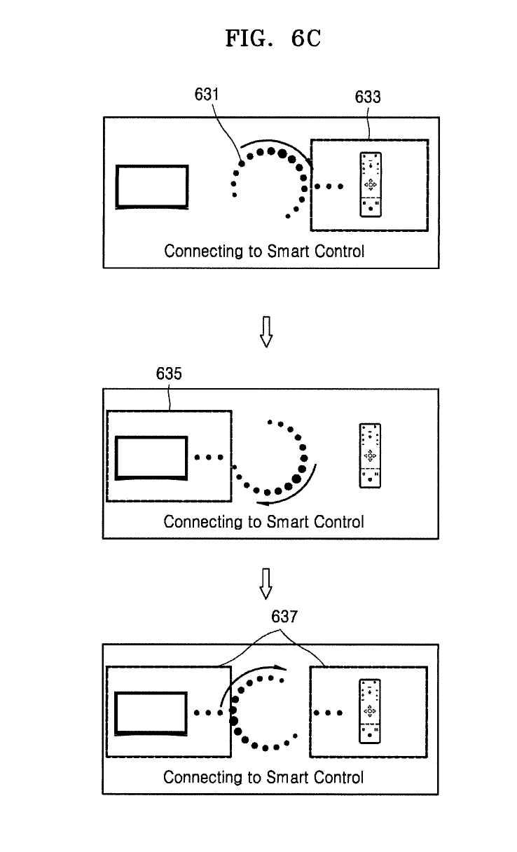

FIG. 6A shows a first user interface of a connection process, displayed by the display apparatus 100.

More specifically, referring to FIG. 6A, the display apparatus 100 may display an animation sequence for representing a state in which a connection process is loaded through a first user interface of the connection process, as in the search process of FIG. 4A.

More specifically, the display apparatus 100 may display a rotating item 611 for representing loading operation through the first user interface.

FIG. 6B shows a changing user interface of the connection process, displayed by the display apparatus 100.

Referring to FIG. 6B, the display apparatus 100 may display an animation sequence for representing a state in which the search process changes from the loading operation to execution operation, through a changing user interface of the connection process.

More specifically, the display apparatus 100 may display a state in which the first user interface changes to the second user interface, through the changing user interface.

For example, the display apparatus 100 may represent operation in which a pairing item representing pairing with another device is created around an item 621. Referring to FIG. 6B, the pairing item around the item 621 is gradually darkened.

The display apparatus 100 may display the rotating item 621, while displaying the operation in which the pairing item is created.

FIG. 6C shows a second user interface of the connection process, displayed by the display apparatus 100.

Referring to FIG. 6C, the display apparatus 100 may display an animation sequence for displaying a state in which a connection process for connecting to another device is being executed, through a second user interface.

For example, the display apparatus 100 may display a pairing item 637 around the item 631 through the second user interface.

Referring to FIG. 6C, the pairing item 637 may include an item 633 representing the control apparatus 200, displayed to the right of the item 631. Also, the pairing item 637 may include an item 635 representing the display apparatus 100, displayed to the left of the item 631.

If the connection process is completed, the display apparatus 100 may remove the pairing item 637 from the second user interface.

Referring to FIGS. 6A to 6C, the display apparatus 100 may control the movement directions of the animated parts of the first user interface, the changing user interface, and the second user interface of the connection process to become the same direction, as in the search process.

Also, the display apparatus 100 may control the animated parts to be connected on a circular trajectory, when displaying the first user interface, the changing user interface, and the second user interface of the connection process sequentially.

Accordingly, the display apparatus 100 may display the first user interface, the changing user interface, and the second user interface of the connection process such that the animation sequences of the first user interface, the changing user interface, and the second user interface are connected seamlessly by each other as if the animation sequences look like an animation sequence.

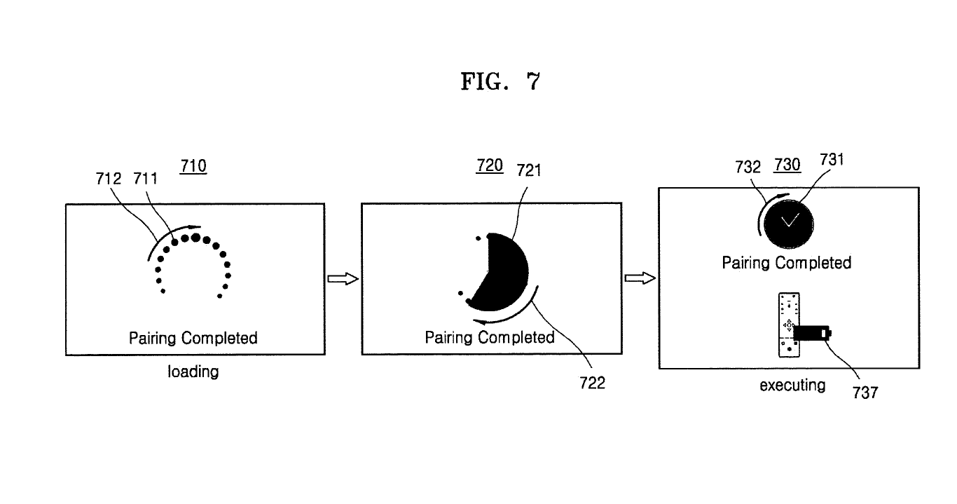

FIG. 7 is a view for describing user interfaces representing a completion process according to an embodiment.

A completion process according to an embodiment may display information 737 about the control apparatus 200 paired with the display apparatus 100. Referring to FIG. 7, the information 737 about the paired control apparatus 200 may be information about a battery power level of the control apparatus 200. Also, in the completion process, information 731 about whether or not the display apparatus 100 has been paired with the control apparatus 200 as the result of a trial for pairing may be displayed. For example, the information 731 about whether or not the display apparatus 100 has been paired with the control apparatus 200 may include a case of pairing completion and a case of pairing failure.

Referring to FIG. 7, the display apparatus 100 may display a first user interface 710 representing loading of a completion process, a changing user interface 720 representing a state in which the first user interface 710 changes to a second user interface 730, and the second user interface 730 representing execution of the completion process.

The first user interface 710, the changing user interface 720, and the second user interface 730 may include animated parts. Herein, the animated parts may be parts displayed by animated.

Arrows shown in FIG. 7 may represent movement directions 712, 722, and 732 of the animated parts.

Hereinafter, exemplary embodiments in which the first user interface 710, the changing user interface 720, and the second user interface 730 of the above-described completion process are displayed respectively will be described in detail.

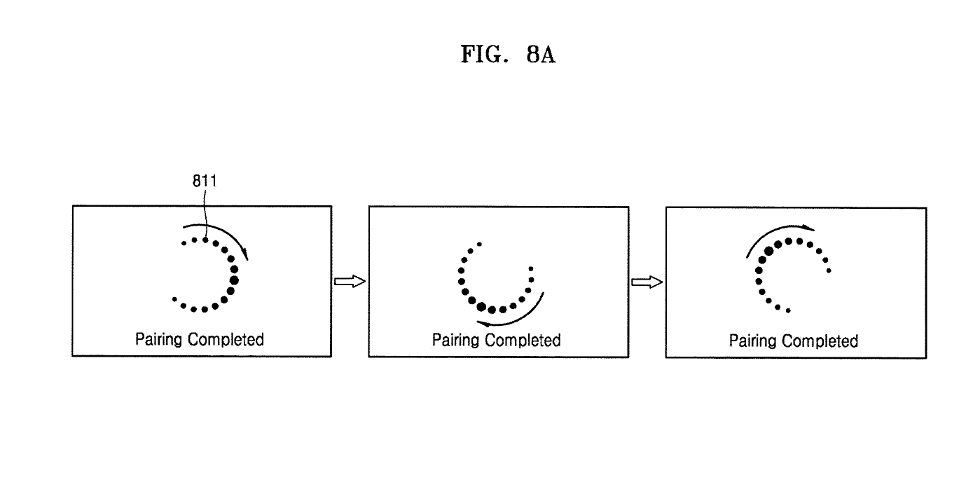

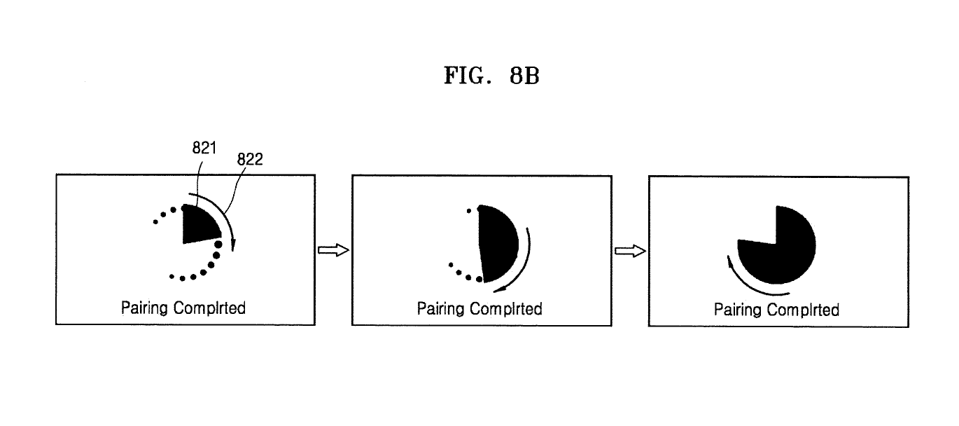

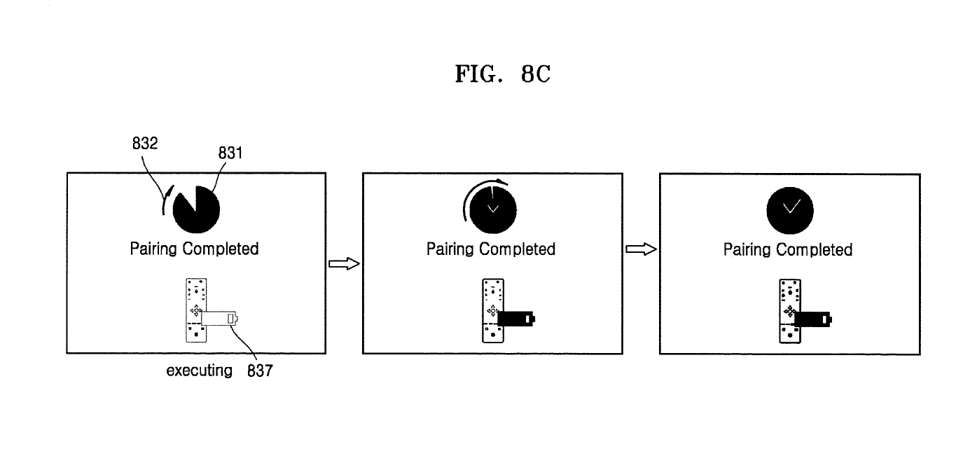

FIG. 8A shows a first user interface of the completion process, displayed by the display apparatus 100.

Referring to FIG. 8A, the display apparatus 100 may display an animation sequence for representing a state in which the completion process is loaded, through the first user interface of the completion process.

More specifically, the display apparatus 100 may display a rotating item 811 for representing loading operation through the first user interface.

FIG. 8B shows a changing user interface of the search process, displayed by the display apparatus 100.

Referring to FIG. 8B, the display apparatus 100 may display an animation sequence for representing a state in which the search process changes from the loading operation to execution operation, through a changing user interface of the search process.

More specifically, the display apparatus 100 may display a state in which the first user interface changes to a second user interface, through the changing user interface.

That is, the display apparatus 100 may display operation in which an item (see 711 of FIG. 7) of the first user interface changes to an item (see 731 of FIG. 7) of the second user interface (see 730 of FIG. 7).

The display apparatus 100 may perform control for displaying an animated part of the changing user interface, based on moving speed of the animated part of the first user interface. Herein, the animated part of the changing user interface may correspond to a part in which an area of the item 821 increases. That is, a direction in which the area of the item 821 increases may correspond to a movement direction 822.

Herein, speed at which the area of the item 821 increases may correspond to speed at which the item (see 811 of FIG. 8A) of the first user interface of FIG. 8A rotates.

Also, according to an embodiment, the display apparatus 100 may display operation of filling the inside of a circular trajectory drawn by the animated part (for example, the item 811 of FIG. 8A) of the first user interface with one of colors included in the second user interface according to a direction of the movement, through the changing user interface.

FIG. 8C shows a second user interface of the completion process, displayed by the display apparatus 100.

Referring to FIG. 8C, the display apparatus 100 may display an animation sequence displaying a state in which a process has been completed, through the second user interface.

For example, the display apparatus 100 may display operation in which an area of the item 831 increases, through the second user interface, as described above with reference to FIG. 8B. Herein, the animated part of the second user interface may correspond to a part in which the area of the item 831 increases. Also, a direction in which the area of the item 831 increases may correspond to a movement direction 832.

Referring to FIGS. 8A to 8C, the display apparatus 100 may control the movement directions of the animated parts of the first user interface, the changing user interface, and the second user interface of the completion process to become the same direction.

Also, referring to FIGS. 8A to 8C, the display apparatus 100 may control the animated parts of the first user interface, the changing user interface, and the second user interface of the completion process such that the movement directions of the animated parts draw a circular trajectory.

Also, the display apparatus 100 may control the animated parts to be connected on the circular trajectory, when displaying the first user interface, the changing user interface, and the second user interface of the completion process sequentially.

Accordingly, the display apparatus 100 may display the first user interface, the changing user interface, and the second user interface of the completion process such that the animation sequences of the first user interface, the changing user interface, and the second user interface are connected seamlessly by each other as if the animation sequences look like an animation sequence.

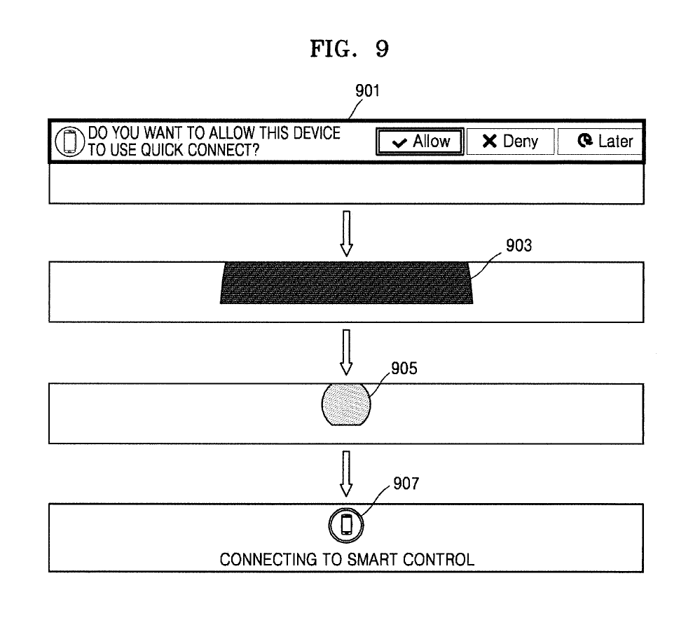

FIG. 9 shows a case of displaying a notification window before loading a process according to an embodiment.

Referring to FIG. 9, the display apparatus 100 may display a notification window 901 before loading a process.

For example, the display apparatus 100 may display a notification window 901 including a user interface for receiving a user input for executing a connection process, before loading the connection process.

The display apparatus 100 may display states 903 and 905 in which the notification window 901 changes to a shape of a first user interface 907, based on an input for executing a process. The first user interface 907 may be a user interface representing loading of the connection process.

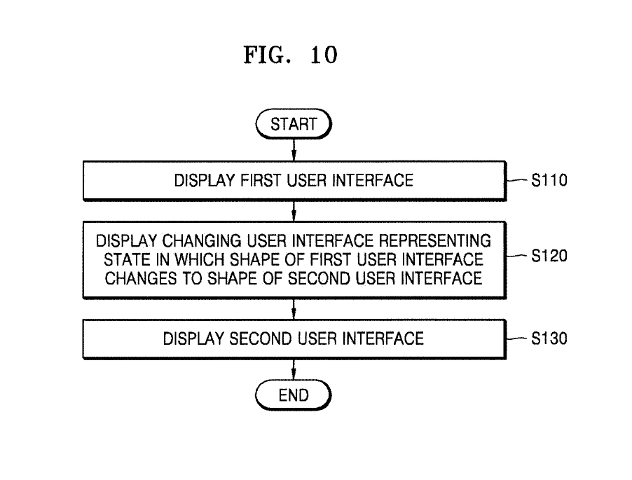

FIG. 10 is a flowchart of a method of operating the display apparatus 100 according to the embodiment.

A method of operating the display apparatus 100 according to an embodiment may be a method for displaying a user interface representing a process for pairing between the display apparatus 100 and another device in the display apparatus 100.

In operation S110, the display apparatus 100 may display a first user interface, in operation S110. The first user interface may be a user interface representing loading of a process.

Then, the display apparatus 100 may display a changing user interface representing a state in which the first user interface changes to a second user interface, in operation S120. More specifically, the changing user interface may be a user interface representing a state in which the first user interface representing loading of the process changes to a second user interface representing execution of the loaded process.

In operation S130, the display apparatus 100 may display the second user interface. The second user interface may be a user interface representing execution of the loaded process.

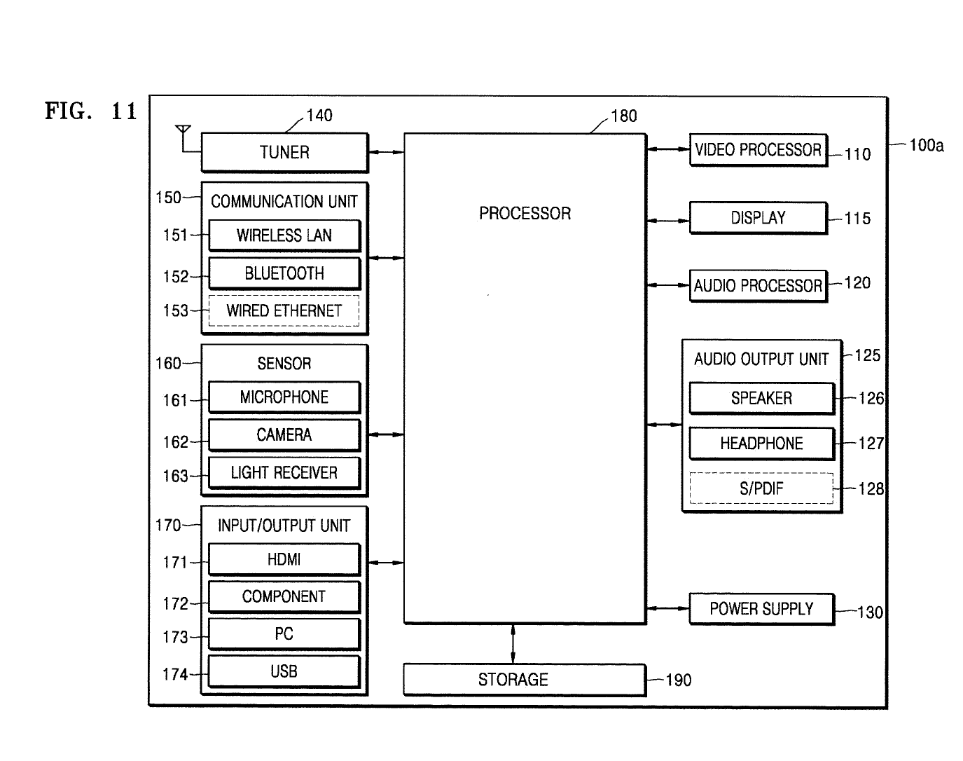

FIG. 11 is a schematic configuration diagram of a display apparatus 100a according to an embodiment.

The display apparatus 100a may include all or a part of the components of the display apparatus 100 of FIG. 2.

Referring to FIG. 11, the display apparatus 100a may include a video processor 110, a display 115, an audio processor 120, an audio output unit 125, a power supply 130, a tuner 140, a communication unit 150, a sensor 160, an input/output unit 170, a processor 180, and a storage 190.

The video processor 110 may process video data received by the display apparatus 100a. The video processor 110 may perform image processing on the video data, such as decoding, scaling, noise filtering, frame rate conversion, resolution conversion, etc.

The display 115 may display video included in broadcasting signals received through the tuner 140 by the control of the processor 180. Also, the display 115 may display contents (for example, moving images) received through the communication unit 150 or the input/output unit 170 by the control of the processor 180. The display 115 may output images stored in the storage 190 by the control of the processor 180. Also, the display 115 may display a voice UI (for example, including a voice command guide) for performing a voice recognition task corresponding to voice recognition, a motion UI (for example, including a voice command guide) for performing a motion recognition task corresponding to motion recognition, or a motion UI (for example, including a user motion guide for motion recognition) for performing a motion recognition task corresponding to motion recognition.

The display 115 according to an embodiment may display a user interface representing a process for pairing between the display apparatus 100 and another device.

The audio processor 120 may process audio data. The audio processor 120 may perform various processing on the audio data, such as decoding, amplification, noise filtering, etc. Meanwhile, the audio processor 120 may include a plurality of audio processing modules in order to process audio corresponding to a plurality of contents.

The audio output unit 125 may output audio included in broadcasting signals received through the tuner 140 by the control of the processor 180. The audio output unit 125 may output audio (for example, voice, sound) input through the communication unit 150 or the input/output unit 170 by the control of the processor 180. Also, the audio output unit 125 may output audio stored in the storage 190 by the control of the processor 180. The audio output unit 125 may include at least one of a speaker 126, a headphone output terminal 127, or a Sony/Philips Digital Interface (S/PDIF) output terminal 128. The audio output unit 125 may include a combination of the speaker 126, the headphone output terminal 127, and the S/PDIF output terminal 128.

The power supply 130 may supply power received from an external power source to the internal components 110 to 190 of the display apparatus 100a by the control of the processor 180. Also, the power supply 130 may supply power output from one or more batteries (not shown) located in the inside of the display apparatus 100a to the internal components 110 to 190 by the control of the processor 180.

The tuner 140 may tune and select only a frequency of a channel which the display apparatus 100a attempts to receive, from among many electromagnetic wave components, through amplification, mixing, resonance, etc. of broadcasting signals received in a wired or wireless fashion. The broadcasting signal may include audio, video, and additional information (for example, Electronic Program Guide (EPG)).

The tuner 140 may receive a broadcasting signal from a frequency band corresponding to a channel number (for example, cable broadcasting No. 506) according to a user input (for example, a control signal received from the control apparatus 200, for example, a channel number input, a channel up-down input, and a channel input onto an EPG screen).

The tuner 140 may receive a broadcasting signal from various sources, such as terrestrial broadcasting, cable broadcasting, satellite broadcasting, Internet broadcasting, etc. The tuner 140 may receive a broadcasting signal from a source, such as analog broadcasting, digital broadcasting, etc. The broadcasting signal received through the tuner 140 may be decoded (for example, audio decoding, video decoding, or additional information decoding) and then divided into audio, video, and/or additional information. The divided audio, video, and/or additional information may be stored in the storage 190 by the control of the processor 180.

The display apparatus 100a may include one or more tuners 140. If the display apparatus 100 includes a plurality of tuners 140 according to an embodiment, a plurality of broadcasting signals may be output to a plurality of windows forming a multi-window screen provided on the display 115.

The tuner 140 may be implemented as an all-in-one with the display apparatus 100a, a separate apparatus (for example, a set-top box (not shown)) electrically connected to the display apparatus 100a and having a tuner, or a tuner (not shown) connected to the input/output unit 170.

The communication unit 150 may connect the display apparatus 100a to an external apparatus (for example, an audio apparatus) by the control of the processor 180. The processor 180 may transmit/receive contents to/from an external apparatus connected through the communication unit 150, download an application from the external apparatus, or perform web-browsing. The communication unit 150 may include one of a wireless LAN 151, Bluetooth 152, and wired Ethernet 153 in correspondence to the performance and structure of the display apparatus 100a. Also, the communication unit 150 may include a combination of the wireless LAN 151, the Bluetooth 152, and the wired Ethernet 153. The communication unit 150 may receive a control signal from the control apparatus 200 by the control of the processor 180. The control signal may be implemented as a Bluetooth type, a RF signal type, or a Wi-Fi type.

The communication unit 150 may further include another short-range communication (for example, Near Field Communication (NFC), Bluetooth Low Energy (BLE)) (not shown), in addition to Bluetooth.

The sensor 160 may sense a user's voice, a user's image, or a user's interaction.

A microphone 161 may receive voice uttered by a user. The microphone 161 may convert the received voice to an electrical signal, and output the electrical signal to the processor 180. The user's voice may include, for example, voice corresponding to a menu or a function of the display apparatus 100a. A recognition range of 4 m as measured from the microphone 161 to a user's location may be recommended as a recognition range of the microphone 161, and the recognition range of the microphone 161 may change in correspondence to the loudness of a user's voice and a surrounding environment (for example, speaker sound, ambient noise).

The microphone 161 may be implemented as an integral type integrated into the display apparatus 100a or a separated type separated from the display apparatus 100a. The separated type of the microphone 161 may be electrically connected to the display apparatus 100 through the communication unit 150 or the input/output unit 170.

It will be easily understood by one of ordinary skill in the art that the microphone 161 can be omitted according to the performance and structure of the display apparatus 100a.

A camera 162 may receive an image (for example, successive frames) corresponding to a user's motion including a gesture made within a camera recognition range. For example, a recognition range of the camera 162 may be a range of 0.1 m to 5 m as measured from the camera 162 to the user. The user's motion may include the user's body part, such as the user's face, the user's expression, the user's hand, the user's fist, or the user's finger, or a motion of the user's body part. The camera 162 may convert the received image into an electrical signal according to the control of the processor 180, and output the electrical signal to the processor 180. The processor 180 may select a menu displayed on the display apparatus 100a using the result of recognition of the received motion, or perform control corresponding to the result of the motion recognition. For example, the processor 180 may control adjustment of the volume or movement of a cursor.

The camera 162 may be configured with a lens (not shown) and an image sensor (not shown). The camera 162 may support optical zoom or digital zoom using a plurality of lenses and image processing. The recognition range of the camera 162 may be set variously according to an angle of the camera 162 and an ambient environment condition. If the camera 162 is configured with a plurality of cameras, the camera 162 may receive a 3Dimensional (3D) still image or a 3D motion using the plurality of cameras.

The camera 162 may be implemented as an integral type integrated into the display apparatus 100a or a separated type separated from the display apparatus 100a. A separate apparatus (not shown) including the separated type of the camera 162 may be electrically connected to the display apparatus 100a through the communication unit 150 or the input/output unit 170.

It will be easily understood by one of ordinary skill in the art that the camera 162 can be omitted according to the performance and structure of the display apparatus 100a.

A light receiver 163 may receive an optical signal (including a control signal) from the external control apparatus 200 through a light window (not shown) of the bezel of the display 115. The light receiver 163 may receive an optical signal corresponding to a user's input (for example, a touch, pressing, a touch gesture, voice, or a motion) from the control apparatus 200. A control signal may be extracted from the received optical signal by the control of the processor 180.

It will be easily understood by one of ordinary skill in the art that the light receiver 163 can be omitted according to the performance and structure of the display apparatus 100a.

The input/output unit 170 may receive video (for example, moving images, etc.), audio (for example, voice, music, etc.), and additional information (for example, EPG, etc.) from the outside of the display apparatus 100a by the control of the processor 180. The input/output unit 170 may include at least one of a High-Definition Multimedia Interface (HDMI) port 171, a component jack 172, a PC port 173, and a USB port 174. Also, the input/output unit 170 may further include at least one of a D-sub port, a Digital Visual Interface (DVI) port, and a DP port according to an implement example.

It will be easily understood by one of ordinary skill in the art that the configuration and operation of the input/output unit 170 can be implemented variously according to embodiments of the present disclosure.

The processor 180 may perform functions of controlling overall operations of the display apparatus 100a and signal flow between the internal components 110 to 190 of the display apparatus 100a, and processing data. If a user's input is received or a condition set in advance and stored is satisfied, the processor 180 may execute Operating System (OS) and various applications stored in the storage 190.

The processor 180 may include a graphic processing unit (GPU) (not shown) for processing graphics corresponding to video. The processor 180 may be implemented as System on Chip (SoC) into which a core (not shown) and a GPU (not shown) are integrated.

The processor 180 according to an embodiment may control the display 115 to display a first user interface representing loading of a process for pairing between the display apparatus 100a and another apparatus, a changing user interface representing a state of change from a shape of the first user interface to a shape of a second user interface representing execution of the loaded process, and the second user interface.

The storage 190 may store various data, programs, or applications for driving and controlling the display apparatus 100a by the control of the processor 180. The storage 190 may store signals or data that are input/output in correspondence to driving of the video processor 110, the display 115, the audio processor 120, the audio output unit 125, the power supply 130, the communication unit 150, the sensor 160, the input/output unit 170, and the user input unit 175.

The storage 190 may store control programs for controlling the display apparatus 100a and the processor 180, and applications initially provided by a manufacturing company or downloaded from the outside. More specifically, the storage 190 may store resources, such as JavaScript files, XML files, etc., used in applications.

The storage 190 according to an embodiment may store a list for applications recently used.

The storage 190 according to an embodiment may store OS that is executed when the display apparatus 100a is powered on. Also, the storage 190 may store Daemon. Also, the storage 190 may store a DRM decoding module for decoding DRM of applications. Also, the storage 190 may store GUIs related to applications, objects (for example, images, text, icons, buttons, etc.) for providing the GUIs, user information, document, database, or related data.

According to an embodiment, the term “storage” may include the storage 190, ROM in which control programs for controlling the display apparatus 100a are stored, RAM which stores signals or data input from the outside or is used as a storage area corresponding to various tasks performed by the display apparatus 100a, or a memory card (for example, a micro SD card, a USB memory) (not shown) installed in the display apparatus 100a. Also, the storage 190 may include non-volatile memory, volatile memory, a Hard Disc Drive (HDD), or a Solid Disc Drive (SDD).

The storage 190 may include a volume control module, a communication control module, a voice recognition module, a motion recognition module, an optical receiver module, a display control module, an audio control module, an external input control module, a power control module, a power control module of an external apparatus connected in a wireless fashion (for example, Bluetooth), voice database (DB), or motion database (DB), which are not shown. The modules and database (not shown) of the storage 190 may be implemented in the form of software, in order to perform a volume control function, a communication control function, a voice recognition function, a motion recognition function, a light reception control function, an audio control function, an external input control function, a power control function, and a display control function to control display of a cursor, in the display apparatus 100a. The processor 180 may perform the individual functions using the software stored in the storage 190.

The storage 190 may include a presentation module. The presentation module may be a module for configuring a display screen. The presentation module may include a multimedia module for reproducing and outputting multimedia contents, and an UI rendering module for processing UIs and graphics. The multimedia module may include a player module, a camcorder module, and a sound processing module. Accordingly, the multimedia module may perform operation of reproducing various multimedia contents to create screens and sound and reproducing them. The UI rendering module may include an image compositor module to compose images, a coordinate compositor module to compose and create coordinates on a screen on which an image is to be displayed, a X11 module to receive various events from hardware, and a 2D/3D UI toolkit to provide a tool for configuring 2D or 3D UIs.

The display apparatus 100a may be electrically connected to a separate external apparatus (for example, a set-top box) (not shown) having a tuner. For example, the display apparatus 100a may be implemented as an analog TV, a digital TV, a 3D-TV, a smart TV, a LED TV, an OLED TV, a plasma TV, a monitor, etc., although not limited to these, which will be easily understood by one of ordinary skill in the art.

The display apparatus 100a may further include a sensor (for example, a light sensor, a temperature sensor, etc.) (not shown) to detect an inside or outside state of the display apparatus 100a.

At least one of the components (for example, 110 to 190) shown in the display apparatus 100a of FIG. 11 may be omitted or at least one component may be added, according to the performance of the display apparatus 100a. Also, the locations of the components (for example, 110 to 190) may change according to the performance or structure of the display apparatus 100a, which will be easily understood by one of ordinary skill in the art.

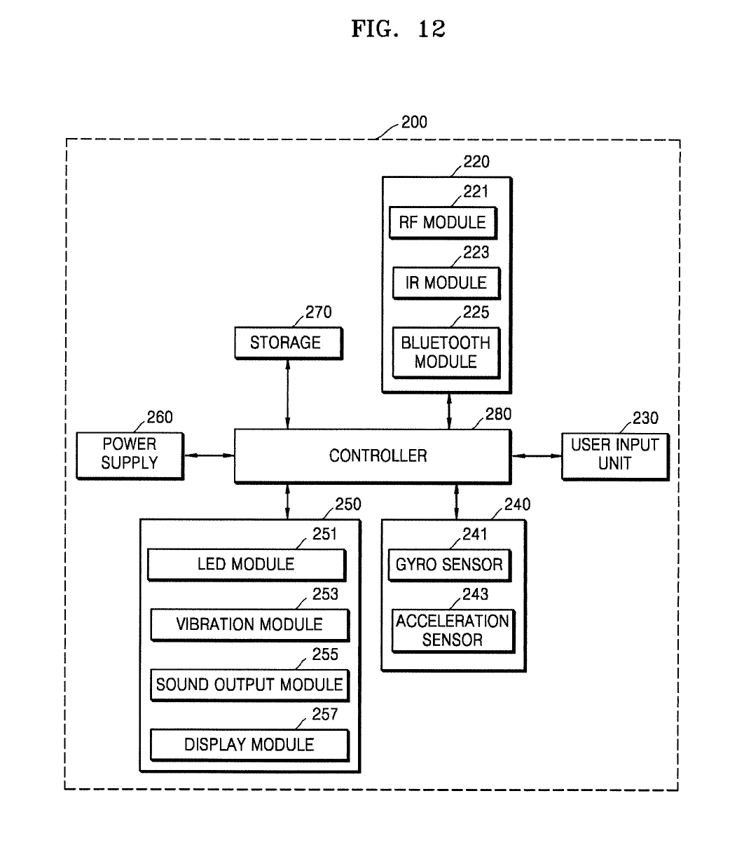

FIG. 12 is a block diagram showing a configuration of a control apparatus 200a according to an embodiment.

The control apparatus 200a may include all or a part of the components of the control apparatus 200 of FIG. 2. Referring to FIG. 12, the control apparatus 200a may include a wireless communication unit 220, a user input unit 230, a sensor 240, an output unit 250, a power supply 260, a storage 270, and a controller 280.

The wireless communication unit 220 may transmit/receive signals to/from the display apparatus according to the above-described embodiments. The wireless communication unit 220 may include an RF module 221 to transmit/receive signals to/from the display apparatus 100 according to an RF communication standard. Also, the control apparatus 200a may include an IR module 223 that can transmit/receive signals to/from the display apparatus 100 according to an IR communication standard. Also, the wireless communication unit 220 may include a Bluetooth module 225 that can transmit/receive Bluetooth type signals to/from the display apparatus 100.

Also, the control apparatus 200a may receive signals transmitted from the display apparatus 100 through the RF module 221. Also, the control apparatus 200a may transmit commands related to power on/off, channel conversion, volume adjustment, etc. to the display apparatus 100 through the IR module 223, as necessary.

The user input unit 230 may be configured as a keypad, buttons, a touch pad, a touch screen, etc. A user may manipulate the user input unit 230 to input a command related to the display apparatus 100 to the control apparatus 200a. If the user input unit 230 includes a hard key button, the user may push the hard key button to input a command related to the display apparatus 100 to the control apparatus 200a. If the user input unit 230 includes a touch screen, the user may touch a soft key of the touch screen to input a command related to the display apparatus 100 to the control apparatus 200a.

Also, the user input unit 230 may include various kinds of input means, such as a scroll key or a jog key, which can be manipulated by the user.

The sensor 240 may include a gyro sensor 241 or an acceleration sensor 243. The gyro sensor 241 may sense information about motion of the control apparatus 200a. For example, the gyro sensor 241 may sense information about motion of the control apparatus 200a based on x, y, and z axes. The acceleration sensor 243 may sense information about moving speed of the control apparatus 200a. Meanwhile, the sensor 240 may further include a distance measurement sensor to sense a distance to the display apparatus 100.

The output unit 250 may output an image or a voice signal corresponding to manipulation of the user input unit 230 or corresponding to a signal received from the display apparatus 100. The user can recognize whether the user input unit 230 is manipulated or whether the display apparatus 100 is controlled, through the output unit 250.

For example, the output unit 250 may include a LED module 251 to illuminate, a vibration module 253 to generate vibrations, a sound output module 255 to output sound, or a display module 257 to output images, when the user input unit 230 is manipulated or when a signal is transmitted/received to/from the display apparatus 100 through the wireless communication unit 220.

The power supply 260 may supply power to the control apparatus 200a. The power supply 260 may stop supplying power when the control apparatus 200a does not move for a predetermined time period to thereby reduce power consumption.

The power supply 260 may resume supplying power when a predetermined key included in the control apparatus 200a is manipulated.

The storage 270 may store various kinds of programs, application data, etc. required for controlling or operating the control apparatus 200a.

The controller 280 may control all operations related to the control of the control apparatus 200a. The controller 280 may transmit a signal corresponding to manipulation of a predetermined key of the user input unit 230 or a signal corresponding to motion of the control apparatus 200a sensed by the sensor 240 to the display apparatus 100 through the wireless communication unit 220.

The display method according to an embodiment may be implemented in a program instruction form that can be executed by various computer means, and may be recorded on computer-readable media. The computer-readable media may also include, alone or in combination with program instructions, data files, data structures, and the like. Program instructions recorded in the media may be the kind specifically designed and constructed for the purposes of the present disclosure or well-known and available to those of ordinary skill in the computer software field. Examples of the computer-readable media include magnetic media, such as hard disks, floppy disks, and magnetic tapes, optical media, such as CD-ROM and DVD, magneto-optical media such as floptical disks, and hardware devices, such as ROM, RAM, flash memory, and the like, specifically configured to store and execute program instructions. Examples of the program instructions include high-level language codes that can be executed on a computer through an interpreter or the like, as well as machine language codes produced by a compiler.

It will be apparent to those of ordinary skill in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

1. A display apparatus comprising:
a display configured to display a user interface representing a process for pairing the display apparatus with another device; and
a processor configured to control the display to display a first user interface representing loading of the process, a changing user interface representing a state of change from the first user interface to a second user interface representing execution of the loaded process, and the second user interface.

2. The display apparatus of claim 1, wherein the first user interface, the changing user interface, and the second user interface include animated parts, and
wherein the processor is further configured to control the animated parts of the first user interface, the changing user interface, and the second user interface to move in a same direction.

3. The display apparatus of claim 2, wherein the processor is further configured to control the animated parts of the first user interface, the changing user interface, and the second user interface to move along a circular trajectory.

4. The display apparatus of claim 3, wherein when the first user interface, the second user interface, and the second user interface are displayed sequentially, the processor is further configured to control the animated parts of the first user interface, the changing user interface, and the second user interface to be connected on the circular trajectory.

5. The display apparatus of claim 4, wherein the processor is further configured to control the changing user interface to be displayed based on a moving speed of the animated part of the first user interface.

6. The display apparatus of claim 5, wherein the changing user interface represents an operation of filling the inside of the circular trajectory drawn by the animated part of the first user interface with one of colors included in the second user interface according to a direction of the movement.

7. The display apparatus of claim 5, wherein the process comprises a connection process for connecting the display apparatus to the other device, and
wherein the changing user interface represents an operation in which a pairing item representing pairing of the display apparatus with the other device is created around the first user interface.

8. The display apparatus of claim 1, wherein the process comprises at least one of a search process for searching for another device to be paired with the display apparatus, a connection process for connecting the display apparatus to the other device, and a completion process for displaying a connection state between the display apparatus and the other device.

9. The display apparatus according to claim 1, wherein the processor is further configured to perform control for displaying a notification window before loading the process, and perform control for displaying a state in which the notification window changes to the first user interface, based on an input for executing the process.

10. The display apparatus of claim 9, wherein the process comprises a connection process for connecting the display apparatus to the other device, and
wherein the notification window includes a user interface for receiving a user input for executing the connection process.

11. A method of displaying a user interface representing a process for pairing a display apparatus with another device in the display apparatus, the method comprising:
displaying a first user interface representing loading of the process;
displaying a changing user interface representing a state of change from the first user interface to a second user interface representing execution of the loaded process; and
displaying the second user interface.

12. The method of claim 11, wherein the first user interface, the changing user interface, and the second user interface include animated parts, and
the animated parts of the first user interface, the changing user interface, and the second user interface move in a same direction.

13. The method of claim 12, wherein the animated parts of the first user interface, the changing user interface, and the second user interface move along a circular trajectory.

14. The method of claim 13, wherein when the first user interface, the second user interface, and the second user interface are displayed sequentially, the animated parts of the first user interface, the changing user interface, and the second user interface are connected on the circular trajectory.

15. The method of claim 14, wherein the displaying of the changing user interface comprises displaying the changing user interface based on a moving speed of the animated part of the first user interface.
